(19) United States
(12) Patent Application Publication
(10) Pub. No.: US 2015/0275572 A1
(43) Pub. Date: Oct. 1, 2015

(54) WINDOW SHADE

(71) Applicant: TAICANG KINGFU PLASTIC MANUFACTURE CO., LTD., Taicang (CN)

(72) Inventor: Szu-Chang HUANG, Changhua County (TW)

(73) Assignee: TAICANG KINGFU PLASTIC MANUFACTURE CO., LTD., Taicang (CN)

(21) Appl. No.: 14/668,569

(22) Filed: Mar. 25, 2015

(30) Foreign Application Priority Data
Mar. 28, 2014 (CN) 201420147636.4

(51) Int. Cl. E06B 9/322

(52) U.S. Cl. CPC E06B 9/322

(57) ABSTRACT

A window shade includes an upper rail, a lower rail, a shade unit, a reel unit and a retarding unit. The reel, unit is provided on one of the upper and lower rails, and includes a first pull cord that is connected to the other one of the upper and lower rails for adjusting the distance between the upper and lower rails. The retarding unit is provided on the one of the upper and lower rails, and includes a first retarder for retarding movement of the first pull cord. The first retarder includes two first retarding shafts that are spaced apart from each other in a horizontal direction. The first pull cord extends around the first retarding shafts.

### CROSS-REFERENCE TO RELATED APPLICATION

This application claims priority of Chinese Application No. 201420147636.4, filed on Mar. 28, 2014.

### BACKGROUND OF THE INVENTION

1. Field of the Invention

The invention relates to a window shade.

2. Description of the Related Art

Referring to FIGS. 1 and 2, a conventional window shade disclosed in Taiwanese Publication No. 363677 includes an upper rail 1, a lower rail 2, a plurality of slats 3, two pull cords 4, a reel unit 5 and an operating unit 6. The slats 3 are disposed between the upper and lower rails 1, 2. The reel unit 5 includes a casing 501 provided on the lower rail 2, two spaced-apart cord reels 502 disposed rotatably in the casing 501, and two spiral springs 503 connected respectively to the cord reels 502. Each of the cord reels 502 has a toothed disk portion 505, and a reel portion 504 on which a respective one of the pull cords 4 is wound. Each of the pill cords 4 extends through the slats 3, and has a distal end connected to the upper rail 1. The spiral springs 503 are adapted to drive the cord reels 502 to rotate in opposite directions, and to wind up the pull cords 4, respectively. The operating unit 6 includes a latch member 601, and a plurality of resilient members 602 each being connected between the latch member 601 and the casing 501 for biasing the latch member 601 toward the cord reels 502. The latch member 601 has two rack portions 603 that are biased by the resilient members 602 to engage separably and respectively the toothed disk portions 505 of the cord reels 502, such that the cord reels 502 cannot rotate relative to the casing 501 and the lower rail 2 is positioned at an arbitrary position.

To adjust the distance between the upper and lower rails 1, 2, the latch member 601 is first pressed against the biasing forces of the resilient members 602 to be separated from the cord reels 502. Then, the lower rail 2 is operable to move toward or away from the upper rail 1 to a desired position while the latch member 601 is being pressed. Subsequently, the latch member 601 is released, and is biased to engage the cord reels 502 again, such that the cord reels 502 cannot rotate relative to the casing 501 and the lower rail 2 is positioned at the desired position.

However, it is inconvenient for a user to simultaneously press the latch member 601 and move the lower rail 2. Moreover, the lower rail 2 may easily be inclined to the upper rail 1 since the actions of the cord reels 502 are independent of each other.

### SUMMARY OF THE INVENTION

Therefore, the object of the present invention is to provide a window shade that can overcome the aforesaid drawbacks associated with the prior art.

Accordingly, a window shade of the present invention includes an upper rail, a lower rail, a shade unit, a reel unit and a retarding unit. The lower rail is disposed under the upper rail. The shade unit is connected between the upper and lower rails. The reel unit is provided on one of the upper and lower rails, and includes a first pull cord that is connected to the other one of the upper and lower rails for adjusting the distance between the upper and lower rails. The retarding unit is provided on the one of the upper and lower rails, and includes a first retarder for retarding movement of the first pull cord. The first retarder includes two first retarding shafts that are spaced apart from each other in a horizontal direction. The first pull cord extends around the first retarding shafts.

### BRIEF DESCRIPTION OF THE DRAWINGS

Other features and advantages of the present invention will become apparent in the following detailed description of the preferred embodiment with reference to the accompanying drawings, of which:

FIG. 1 is a front view of a conventional window shade disclosed in a prior art reference, Taiwanese Publication No. 363677;

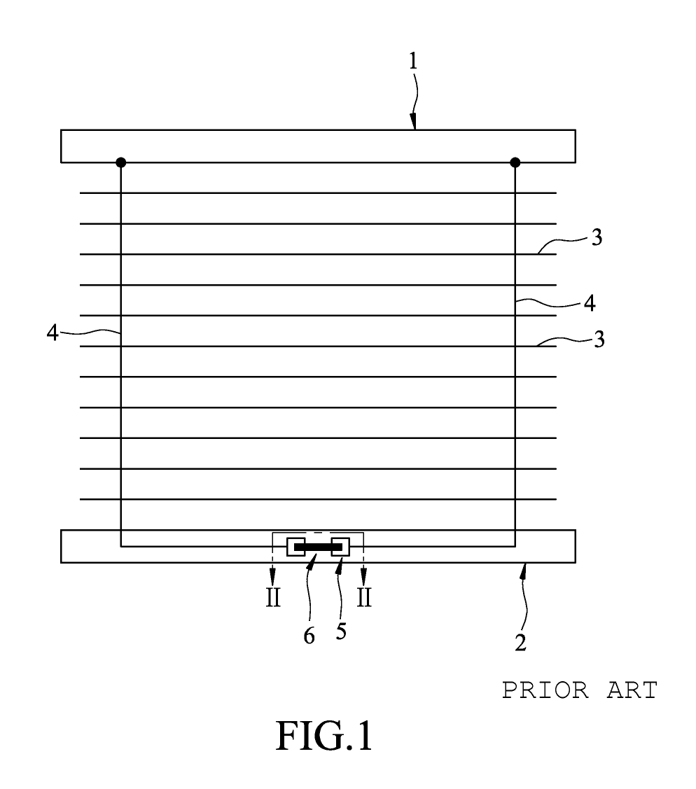

FIG. 2 is a fragmentary sectional view of the conventional window shade taken along line in FIG. 1;

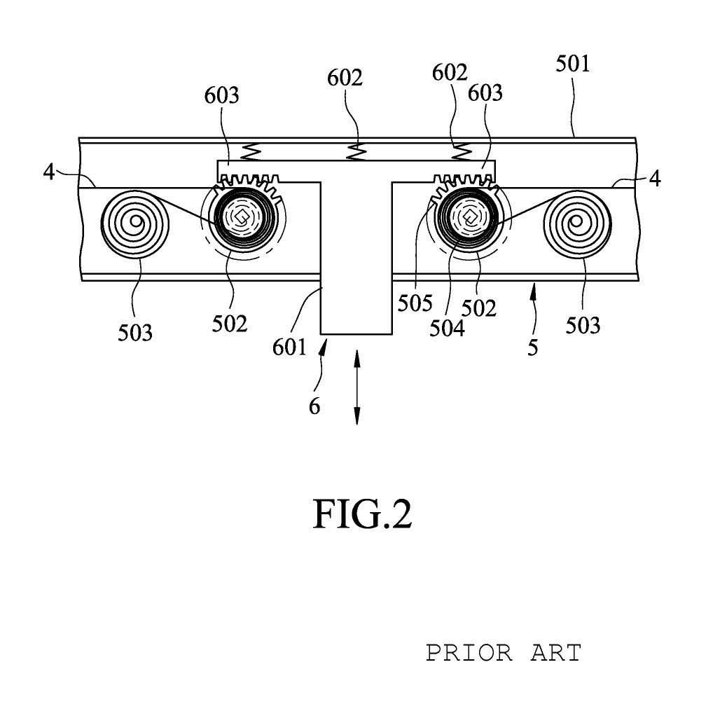

FIG. 3 is a front view of a preferred embodiment of a window shade according to the invention;

FIG. 4 is a fragmentary perspective view of the preferred embodiment illustrating a reel unit and a retarding unit;

FIG. 5 is a partly exploded and partly cutaway perspective view of the preferred embodiment illustrating the reel unit and the retarding unit;

FIG. 6 is a sectional view of the reel unit and the retarding unit of the preferred embodiment;

FIG. 7 is a schematic sectional view of the reel unit and the retarding unit of the preferred embodiment; and

FIG. 8 is another schematic sectional view of the reel unit and the retarding unit of the preferred embodiment.

### DETAILED DESCRIPTION OF THE PREFERRED EMBODIMENT

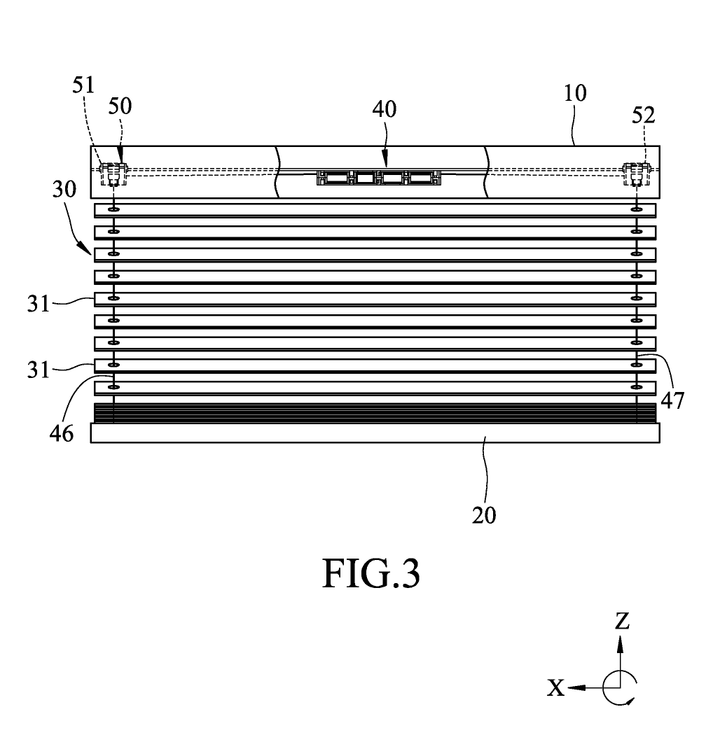

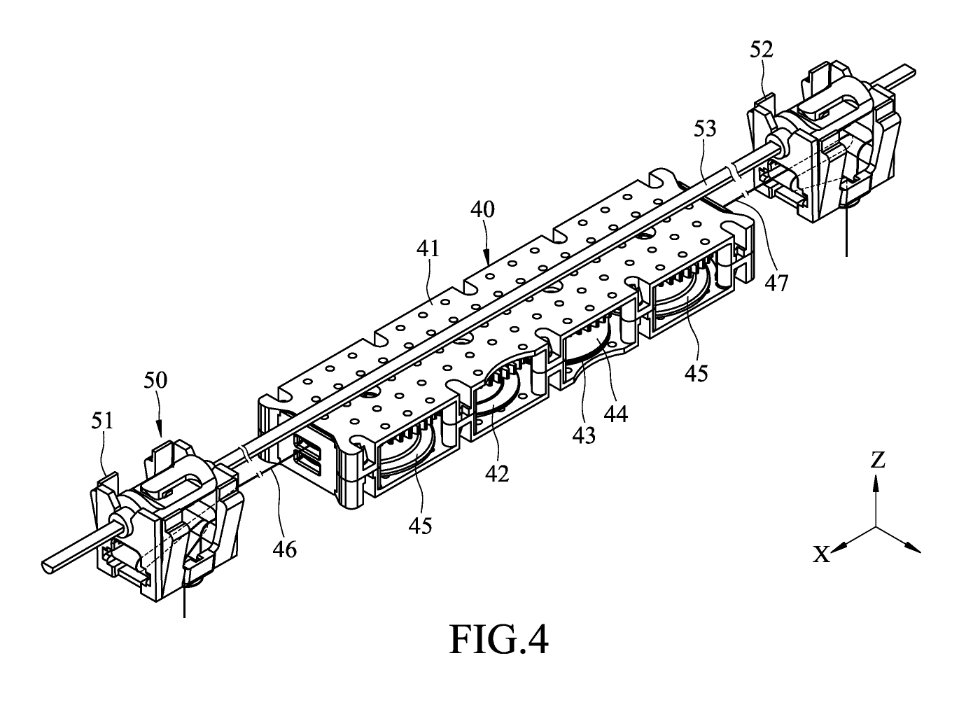

As shown in FIGS. 3 and 4, a preferred embodiment of a window shade according to the present invention includes an upper rail 10, a lower rail 20, a shade unit 30, a reel unit 40 and a retarding unit 50.

The upper rail 10 extends in a horizontal direction (X). The lower rail 20 extends in the horizontal direction (X), and is disposed. under the upper rail 10. The shade unit 30 is connected between the upper and lower rails 10, 20. In this embodiment, the shade unit includes a plurality of slats 31 that are interconnected by ladder strings (for simplification, not shown). However, the shade unit 30 may be configured as a fabric, a pleated shade or a honeycomb shade. The lower rail 20 is movable relative to the upper rail 10 in a vertical direction (Z) between an upper position where the lower rail 20 is close to the upper rail 10 and the slats 31 are stacked on the lower rail 20, and a lower position where the lower rail 20 is distal from the upper rail 10 and no slat 31 is stacked on the lower rail 20.

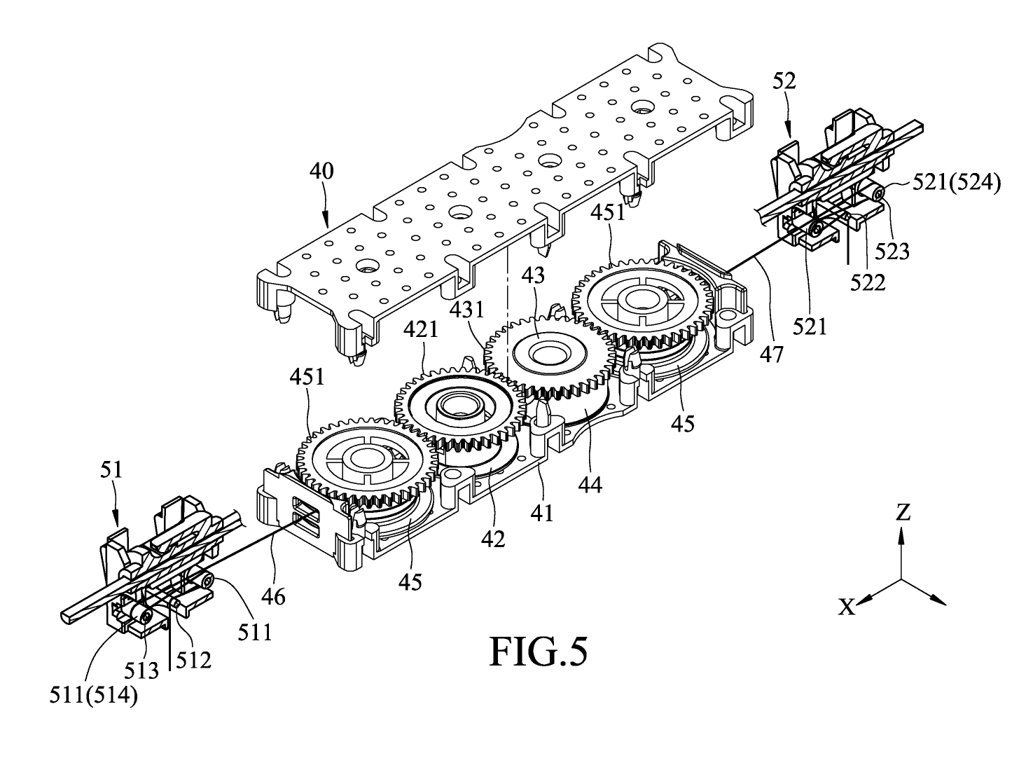

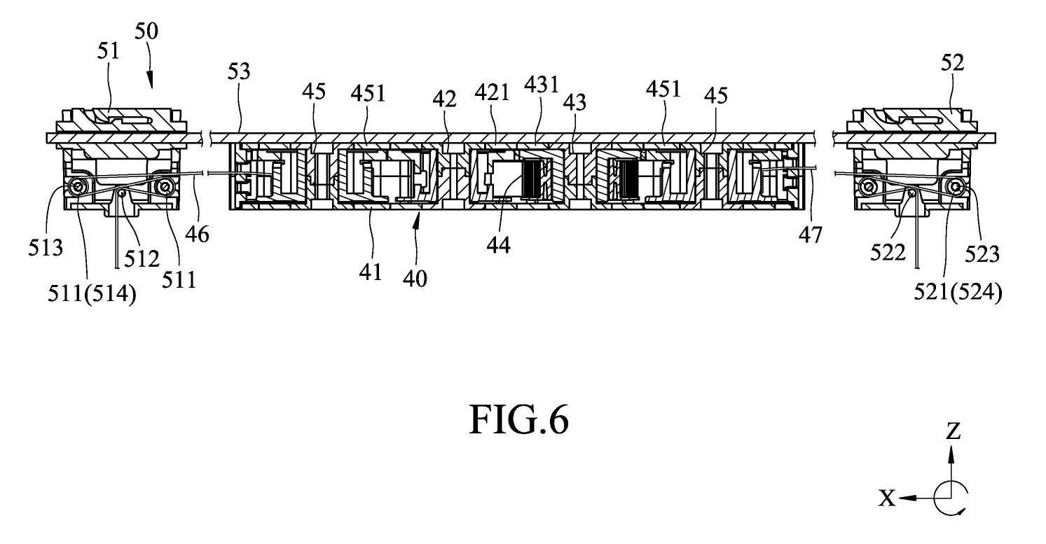

Referring further to FIGS. 5 and 6, the reel unit 40 is provided on the upper rail 10, and includes a casing 41, a driving wheel 42 disposed rotatably in the casing 41, a spring reel 43 disposed rotatably in the casing 41 and coupled to the driving wheel 42, a spiral spring 44 having opposite ends that are connected respectively to the driving wheel 42 and the spring reel 43, two spaced-apart cord reels 45 disposed rotatably in the casing 41 and coupled respectively to the driving wheel 42 and the spring reel 43, and first and second pull cords 46, 47.

The driving wheel 42 has a toothed disk portion 421. The spring reel 43 has a toothed disk portion 431 that meshes with the toothed disk portion 421 of the driving wheel 42. Each of the cord reels 45 has a toothed disk portion 451 that meshes with the toothed disk portion 421, 131 of a respective one of the driving wheel 42 and the spring reel 43.

The retarding unit 50 is provided on the upper rail 10, and includes a first retarder 51, a second retarder 52 and a connecting rod 53. The first and second retarders 51, 52 are spaced apart from each other in the horizontal direction (X). The connecting rod 53 extends in the horizontal direction (X) and interconnects the first and second retarders 51, 52. In this embodiment, the first and second retarders 51, 52 are disposed respectively at two ends of the casing 41 that are opposite to each other in the horizontal direction (X).

The first retarder 51 includes two first retarding shafts 511 that are spaced apart from each other in the horizontal direction (X), and a first rod member 512 that is disposed below the first retarding shafts 511 and that is located between the first retarding shafts 511 in the horizontal direction (X). Each of the first retarding shafts 511 includes a core pin 513, and a roller member 514 sleeved rotatably on the core pin 513.

The first pull cord 46 has a wound Portion and an unwound portion. The wound portion has a distal end connected to one of the cord reels 45 (the left cord reel 45), and is wound on the left cord reel 45. The unwound portion extends around the first retarding shafts 511 and the first rod member 512 of the first retarder 51, extends through the slats 31 of the shade unit 30, and has a distal end connected to the lower rail 20. Preferably, the unwound portion of the first pull cord 46 first extends from the left cord reel 45 and around the roller member 514 of one of the first retarding shafts 511 (i.e. the left first retarding shaft 511) that is distal from the casing 41, then around the roller member 514 of the other one of the first retarding shafts 511 (i.e. the right first retarding shaft 511) that is proximate to the casing 41, and finally around the first rod member 512.

The second retarder 52 includes two second retarding shafts 521 that are spaced apart from each other in the horizontal direction (X), and a second rod member 522 that is disposed below the second retarding shafts 521 and that is located between the second retarding shafts 521 in the horizontal direction (X). Each of the second retarding shafts 521 includes a core pin 523, and a roller member 524 sleeved rotatably on the core pin 523.

The second pull cord 47 has a wound portion and an unwound portion, wherein the wound portion has a distal end connected to the other one of the cord reels 45 (the right cord reel 45), and is wound on the right cord reel 45, and the unwound portion extends around the second retarding shafts 521 and the second rod member 522 of the second retarder 52, and through the slats 31 of the shade unit 30, and has a distal end connected to the lower rail 20. Preferably, the unwound portion of the second pull cord 47 first extends from the right cord reel 45 and around the roller member 524 of one of the second retarding shafts 521 (i.e. the right second retarding shaft 521) that is distal from the casing 41, then around the roller member 524 of the other one of the second retarding shafts 521 (i.e. the left second retarding shaft 521) that is proximate to the casing 41, and finally around the second rod member 522.

In this embodiment, the spiral spring 44 has a portion wound on the driving wheel 42 and another portion wound on the spring reel 43, and tends to be entirely wound on the spring reel 43 to generate a restoring force for driving the driving wheel 42 and the spring reel 43 to rotate synchronously in opposite directions, and to thereby drive the cord reels 45 to rotate synchronously in opposite directions, so as to respectively wind up the unwound portions of first and second pull cords 46, 47 to rise the lower rail 20. When the lower rail 20 is pulled by a downward force to move downwardly, the cord reels 45 are respectively driven to rotate in opposite directions against the restoring force of the spiral spring 44 to respectively unwind the wound portions of the first and second pull cords 46, 47.

The first retarder 51 is adapted for providing a static frictional force to retard the movement of the first pull cord 46 in both of a wind-up direction and an unwinding direction. It is noted that the roller member 514 of each of the first retarding shafts 511 may be removed, so that the first pull cord 46 extends around and contact the core pin 513 of the first retarding shaft 511 directly. A first retarding shaft 511 with the roller member 514 being removed is able to provide a greater static frictional for than that provided by the first retarding shaft 511 with the roller member 514 when the first pull cord 46 tends to move relative to the first retarding shaft 511. Therefore, the static frictional force provided by the first retarder 51 is adjustable through removal or installation of the roller members 514.

Similarly, the second retarder 52 is adapted for providing a static frictional force to retard the movement of the second pull cord 47 in both of a wind-up direction and an unwinding direction. The roller member 524 of each of the second retarding shafts 521 may be removed, so that the second pull cord 47 extends around and contacts the core pin 523 of the second retarding shaft 521 directly. A second retarding shaft 521 with the roller member 524 being removed is able to provide a greater static frictional force than that provided by the second retarding shaft 521 with the roller member 524 when the second pull cord 47 tends to move relative to the second retarding shaft 522. Therefore, the static frictional force provided by the second retarder 52 is adjustable through removal or installation of the roller members 524.

In this embodiment, when the lower rail 20 is at the lower position, the restoring force of the spiral spring is greater than the sum of the maximum static frictional force of the first retarder 51 and the maximum static frictional force of the second retarder 52, and is smaller than the sum of the weight of the lower rail 20, the maximum Static frictional force of the first retarder 51 and the maximum static frictional force of the second retarder 52. When the lower rail 20 is at the upper position, the restoring force of the spiral spring 44 is greater than the sum of the maximum static frictional force of the first retarder 51 and the maximum static frictional force of the second retarder 52, and the total weight of the lower rail 20 and the slates 31 stacked on the lower rail 20 is smaller than the sum of the restoring force of the spiral spring 44, the maximum static frictional force of the first retarder 51 and the maximum static frictional force of the second retarder 52. That is, when the lower rail 20 is at any position between the upper and lower position, the restoring force of the spiral spring 44 is greater than the sum of the maximum static frictional force of the first retarder 51 and the maximum static frictional force of the second retarder 52, and the difference between the restoring force of the spiral spring 44 and the total weight of the lower rail 20 and the slates 31 stacked on the lower rail 20 is smaller than the sum of the maximum static frictional force of the first retarder 51 and the maximum static frictional force of the second retarder 52. As such, the lower rail 20 can be retained at an arbitrary position (see FIG. 3) between the upper and lower positions when there is no external force applied on the lower rail 20, and can be pulled upwardly when the total weight of the lower rail 20 and the slates 31 stacked on the lower rail 20 is balanced by an external force.

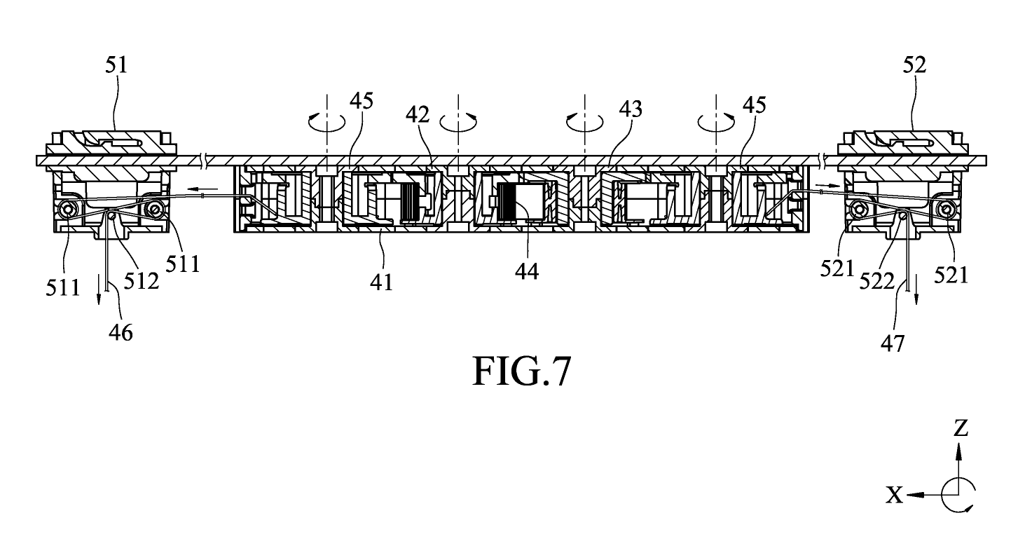

Referring to FIGS. 3 and 7 to lower the lower rail 20, a downward external force that is greater than the difference between the total weight of the lower rail 20 and the slates 31 stacked on the lower rail 20 and the sum of the restoring force of the spiral spring 44, the maximum static frictional force of the first retarder 51 and the maximum static frictional force of the second retarder 52 is applied on the lower rail 20, such that the cord reels 45 are driven to rotate in opposite directions, so as to drive the driving wheel 42 and the spring reel 43 to rotate in opposite directions against the restoring force of the spiral spring 44, and to respectively unwind the wound portions of the first and second pull cords 46, 47 to lower the lower rail 20 The application of the downward external force is stopped when the lower rail 20 is moved downwardly to a desired position, and the retarding unit 5 subsequently retards the movement of the first and second pull cords 46, 47 to retain the lower rail 20 at the desired position.

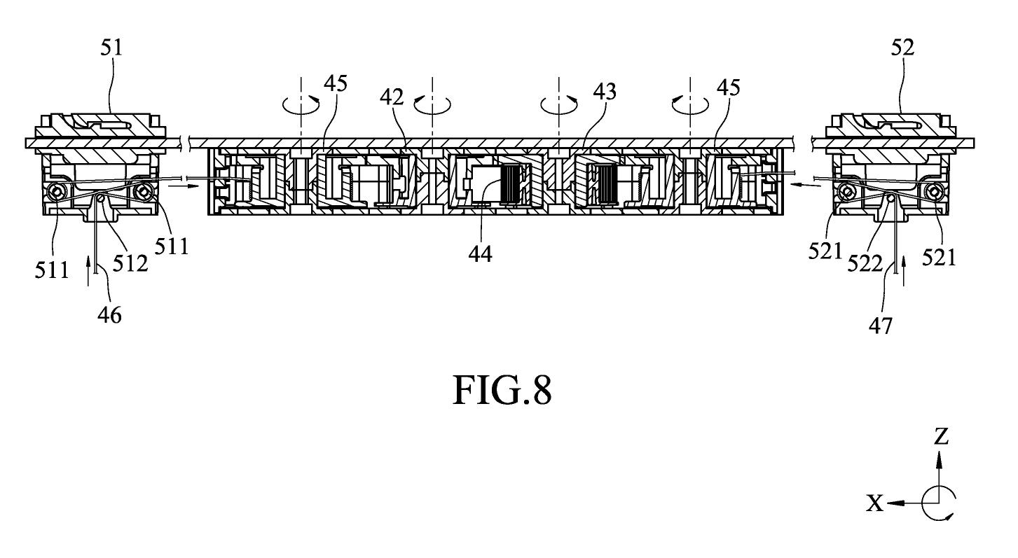

Referring to FIGS. 3 and 8, to rise the lower rail 20, an upward external force that is greater than the difference between the restoring force of the spiral spring 44 and the sum of the total weight of the lower rail 20 and that slats 31 stacked on the lower rail 20, the maximum static frictional force of the first retarder 51 and the maximum static frictional force of the second retarder 52 is applied to the lower rail 20, such that the cord reels 45 are driven by the restoring force of the spiral spring 44 to rotate synchronously in opposite directions, so as to wind up the unwound portions of the first and second pull cords 46, 47 to lift the lower rail 20. The application of the upward external force is stopped when the lower rail 20 is moved upwardly to a desired position, and the retarding unit 5 subsequently retards the movement of the first and second pull cords 46, 47 to retain the lower rail 20 at the desired position

It is noted that, by virtue of engagement among the toothed disk portions 421, 431, 451 of the driving wheel 42, the spring reel 43 and the cord reels 45, the driving wheel 42, the spring reel 43 and the cord reels 45 are compelled to rotate synchronously, such that the lower rail 20 would not be inclined to the upper rail 10 during adjustment of the window shade of this invention.

It is noted that the maximum static frictional forces of the first and second retarders 51, 52 are adjustable through removal or installation of the roller members 514, 524 in view of the weight of the lower rail 20 and the number of the slats 31.

To sum up, during adjustment of the window shade of this invention, a user can directly apply an external force to the lower rail 20 to rise or lower the lower rail 20 to a desired position without additional operation. Moreover, by virtue of the reel unit 40 of this invention, the lower rail 20 would not be inclined to the upper rail 10 during adjustment of the window shade.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A constituent assembly adapted for use in a window shade, the window shade including an upper rail, a lower rail disposed under the upper rail, a shade unit. connected between the upper and lower rails, and a cord reel provided on one of the upper and lower rails, said constituent assembly comprising:
a first pull cord adapted to be partially wound on the cord reel and connected to the other one of the upper and lower rails for adjusting the distance between the upper and lower rails; and
a retarding unit adapted to be provided on the one of the upper and lower rails, and including a first retarder for retarding movement of said first pull cord, said first retarder including two first retarding shafts that are spaced apart from each other in a horizontal direction, said first pull cord extending around said first retarding shafts.

2. The constituent assembly as claimed in claim 1, wherein at least one of said first retarding shafts includes a core pin, and a roller member sleeved rotatably on said core pin.

3. The constituent assembly as claimed in claim 2, wherein said first retarder further includes a first rod member that is disposed below said first retarding shafts and that is located between said first retarding shafts in the horizontal direction, said first pull cord extending around said first retarding shafts and said first rod member in a manner that said first pull cord first extends from the cord reel and around one of said first retarding shafts that is distal from the cord reel, then around the other one of said first retarding shafts that is proximate to the cord reel, and finally around said first rod member.

4. The constituent assembly as claimed in claim 3, the window shade further including another cord reel that is provided on the one of the upper and lower rails, said constituent assembly further comprising:
a second pull cord adapted to be partially wound on the another cord reel and connected to the other one of the upper and lower rails for adjusting the distance between the upper and lower rails; and
a second retarder including two second retarding shafts that are spaced apart from each other in the horizontal direction, said second pull cord extending around said second retarding shafts.

5. The constituent assembly as claimed in claim 4, wherein at least one of said second retarding shafts includes a core pin, and a roller member sleeved rotatably on said core pin.

6. The constituent assembly as claimed in claim 5, wherein said second retarder further includes a second rod member that is disposed below said second retarding shafts and that is located between said second retarding shafts in the horizontal direction, said second pull cord extending around said second retarding shafts and said second rod member in a manner that said second pull cord first extends from the another cord reel and around one of said second retarding shafts that is distal from the another cord reel, then around the other one of said second retarding shafts that is proximate to the another cord reel, and finally around said second rod member.

7. The constituent assembly as claimed in claim 4, wherein said first and second retarders are spaced apart from each other in the horizontal direction, said retarding unit further including a connecting rod that extends in the horizontal direction, and that interconnects said first and second retarders.

8. The constituent assembly as claimed in claim 4, wherein said first and second retarders being adapted to be disposed respectively at two opposite sides of the cord reel and the another cord reel that are opposite to each other in the horizontal direction.

9. The constituent assembly as claimed in claim 4, wherein said retarding unit is adapted to be provided on the upper rail, each of said first and second pull cords having a distal end connected to the lower rail.
